(19) United States
(12) Patent Application Publication
(10) Pub. No.: US 2008/0230331 A1
(43) Pub. Date: Sep. 25, 2008

(54) Electric Brake Actuating Assembly

(75) Inventor: Nui Wang, Victoria (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: PBR Australia Pty Ltd., East Bentleigh (AU)

(21) Appl. No.: 11/597,875

(22) PCT Filed: May 27, 2005
(86) PCT No.: PCT/AU05/00754

§ 371 Date: May 5, 2008

(30) Foreign Application Priority Data
May 27, 2004 (AU) 2004902840

(51) Int. Cl. F16D 65/21

(52) U.S. Cl. 188/156

(57) ABSTRACT

An electric brake actuating assembly (10), including a rotatable actuator (11) and electric drive means for driving the rotatable actuator (11) to rotate, a pair of load transfer members (16, 17) disposed respectively on opposite sides of the rotatable actuator (11) and each load transfer member (16, 17) including three connections A, A1, B, B1, C, C1. Link arrangement (14) connects respective first connections A, A1 of load transfer members (16, 17) an actuating cable arrangement (15) connects respective second connections B, B1 of load transfer members (16, 17) and extends in connection in with rotatable actuator (11), and a brake assembly connection (18, 19) extends from respective third connections C, C1 of load transfer members (16, 17) for connection to respective brake assemblies. The arrangement being such that upon rotation of rotatable actuator (11) in a brake actuation direction, a pull load is applied through actuating cable arrangement (15) to second connections C, C1 of load transfer members (16, 17) to cause those members to rotate about first connections A, A1 and to cause a shift in the position of third connections B, B1 for application of an actuating load on brake assembly connections (18, 19) for actuation of the brake assemblies.

The present invention relates to an electric brake actuating assembly for actuating the brakes of an automotive vehicle. It will be convenient to describe the invention as it relates to the actuation of the parking brakes of a vehicle, but it is to be appreciated that the invention could be applied to other forms of brake, such as service brakes of the drum or disc kind.

Electric brake actuating assemblies have been introduced into automotive vehicles in recent times in particular for parking brake actuation. By employing an electric brake actuator, the vehicle driver can initiate parking brake application and release by a switch located in the vehicle cabin, so that the effort of manual application of the parking brakes is eliminated. Additionally, electric brake actuators are considered desirable because they can be controlled by onboard computer, to enhance driving safety, in a manner in which manual parking brake actuators cannot.

While the benefits of electric brake actuating assemblies are known, assemblies which are commercially acceptable are not readily available. It is therefore an object of the present invention to provide an electric brake actuating assembly which meets with general commercial acceptance.

According to the present invention, there is provided, an electric brake actuating assembly, including a rotatable actuator and electric drive means for driving the rotatable actuator to rotate, a pair of load transfer members disposed respectively on opposite sides of the rotatable actuator and each load transfer member including three connections, a link arrangement connects respective first connections of the load transfer members, an actuating cable arrangement connects respective second connections of the load transfer members and extends in connection with the rotatable actuator, and a brake assembly connection extends from respective third connections of the load transfer members, for connection to respective brake assemblies, the arrangement being such that upon rotation of the rotatable actuator in a brake actuation direction, a pull load is applied through the actuating cable arrangement to the second connections of the load transfer members to cause those members to rotate about the first connections and to cause a shift in the position of the third connections for application of an actuating load on the brake assembly connections for actuation of the brake assemblies.

The rotatable actuator of the present invention can take any one of the forms described in applicants International application WO 03/008248, and in which the actuating cable arrangement comprises a single and continuous cable that extends in connection with the rotatable actuator and which can either be withdrawn for brake application, or extended for brake release, upon rotation of the actuator respectively in one of forward or reverse directions. The content of the specification of that application is thereby incorporated herein in its entirety by cross-reference.

The rotatable actuator could also take other forms, such as a form in which the actuating cable arrangement includes a pair of cables, each of which is fixed to the actuator and each of which extends to a respective load transfer member. Thus the rotatable actuator can take a form of a barrel, having the ends of the pair of cables anchored thereto in any suitable manner. Still alternatively, the rotatable actuator could be a rotatable element, such as an elongate element in which the ends of a pair of cables of the actuating cable arrangement are connected to or anchored along the length of the element, preferably at or towards each end thereof.

Whatever form the rotatable actuator has, the requirement of the actuator is to facilitate extension of cables therefrom in two generally opposite directions and to retract the cables in one direction of rotation and to allow return of the cables from the retracted condition by rotation in a second and reverse direction.

In the preferred form of the invention, the rotatable actuator will include a rotatable disc that has a circular outer periphery defining a cable groove which locates and accommodates a portion of the length of the cable when the disc is rotating. The disc can however be otherwise shaped, such as oval shaped and the shape selected for the disc can be selected on the basis of how the cable load is to be applied to the brake assemblies. For example, it may be that a greater cable shift or retraction is desirable at the initial stages of brake application to take up the running clearance in the brake assemblies or in other words, to bring the brake pads into engagement with the braking surface of the disc or drum from a position of clearance, whereafter a reduced amount of shift, but an increased torque is required to actually achieve the required pressure between the brake pads and the braking surface. Thus, the geometric shape of the rotatable actuator can be selected to provide different operating characteristics.

In the present invention, the rotatable actuator advantageously can be fixed in place or grounded, such as to a suitable anchor point on the chassis of a vehicle. The rotatable actuator could for example, be fixed to the rear axle of the vehicle, or to the differential, and may be housed within a suitable sealed housing to protect it from exposure to mud, water, dirt and other contaminants the underneath of a vehicle is readily exposed to. Thus, it is not necessary to employ a flexible bracket of the kind disclosed in applicant's International application WO 03/008248 for equalisation purposes, for reasons that will be discussed later herein. Advantageously, by fixing or grounding the rotatable member, a less complex mounting arrangement can be employed.

The link arrangement extends between the load transfer members and is operable to substantially restrain movement of those members, other than rotational movement about the first connections. The link arrangement preferably includes a cable for load transmission under tension and preferably the arrangement comprises a single cable, which is anchored at opposite ends to the respective load transfer members and which extends uninterrupted and directly between those members. Alternatively, the single cable could extend indirectly between the load transfer member by suitable routing. Still alternatively, the link arrangement can comprise or include a rigid member that can transmit load under compression or tension, such as a rod. The link arrangement is operable to connect the load transfer members and to substantially maintain a set distance between the points of the connections of those members with the link arrangement By maintaining that distance as set, the load transfer members can rotate about the first connections when the actuator cable arrangement applies a pull load at its points of connection to load transfer members.

As previously discussed, the actuator cable arrangement extends in connection with each of the load transfer members and with the rotatable actuator. The actuator cable arrangement can be a continuous cable or can include two or more separate cables as required. The construction of the actuator cable arrangement is in part dependent on the form of the rotatable actuator and for example, in the actuators illustrated in the figures of International application WO 03/008248, a continuous cable which is connected at either end to respective load transfer members can be employed. If however the rotatable member took an alternative form, for example an elongate element such as discussed above, then two separate cables can be provided, each connected at one end to a load transfer member and at the other end to the rotatable member. It will be understood from reading the specification of International application WO 03/008248, that an actuator that can accommodate a continuous cable, provides certain advantages, particularly in respect of ease of assembly.

The rotatable member has the requirement of retracting and extending the actuating cable arrangement for respective brake application and release. The rotatable member is required to retract each cable, or section of cable, that extends to the load transfer members for brake application. By that retraction, the load transfer members are caused to pivot about the first connections of the link arrangement and by that rotation, to pull or retract the brake assembly connections for brake application. Rotation of the rotatable member in the opposite direction permits the load transfer members return rotation again about the first connections, by extension of the actuating cable arrangement from the brake release.

The brake assembly connections can take any suitable arrangement and can for example include connections which can act under each of compression or tension. In compression, the brake assembly connections might include push rods. In tension, the connections can be cables and this is preferred. These latter connections can therefore comprise brake cable arrangements which advantageously can take the form of, or be similar to present cable arrangements employed for parking brake application. Thus, a cable which is housed in a conduit can extend from each brake assembly to the load transfer arrangement. The conduit can be fixed at each of the brake assembly and adjacent a load transfer member, with the cable freely movable within the conduit. Preferably the end of the conduit fixed adjacent the load transfer member is fixed close to that member and preferably the conduit is fixed to a housing such as described above, that houses the electric brake actuating assembly or to any other suitable part of a vehicle to which assembly is installed or employed. In this arrangement, the cables of the brake cable arrangement can be enclosed completely within the conduit and the housing, without being exposed externally.

The load transfer members can take any suitable form and in one form they are elongate levers and the three connections are spaced apart lengthwise of the levers. In one form, the first and second connections are formed or provided at opposite distal ends of the levers, while the third connection is formed intermediate the first and second connections. In this preferred arrangement, the brake assembly connections act in tension and therefore can take the preferred form of a cable. This also occurs if the third connection is provided at the opposite side of the second connection to the first connection. Alternatively, if the third connection is on the opposite side of the first cable connection to the second cable connection, the brake assembly connection must be operable to act in compression.

The assembly of the invention can be such as to provide for load magnification or intensification, or for load reduction, through the load transfer members to the brake assembly connections. The extent of magnification for example is a function of the ratio of the respective differences in distance between the first and second connections (distance y), and the first and third connections (distance x). Thus, if each of the connections is equally spaced apart so that the distance y between the first and second connections is twice the distance x between the first and third connections, then load magnification will be 2 to 1 i.e. one unit of force in, magnified to 2 units of force out. The ratio of magnification can be varied as required by altering the spacing of the connections, so that the ratio y:x changes. Load reduction can equally be arranged by appropriate positioning of the respective load transfer member connections.

The assembly of the invention is arranged to that the load transfer members are subject to component forces at the first and second connections which act in a direction opposite to the force which acts at the third connection. In use, the forces acting at each of the connections is preferably such as to maintain the link and actuating arrangements and the brake assembly connections, in tension.

Preferably the load transfer members can float in order to facilitate load equalisation when required. That is, if the displacement demanded by one of the brake assembly connections is greater than the other, a shift in the floating positions of the load transfer members can equalise the respective loads. Thus, in an assembly according to the invention each of the rotatable actuator and the brake assembly connections can be fixed, while the load transfer members can be arranged to float, and by that arrangement, load equalisation can be achieved in the loads applied to the brake assemblies.

For a better understanding of the invention and to show how it may be performed, embodiments thereof will now be described, by way of non-limiting example only, with reference to the accompanying drawings.

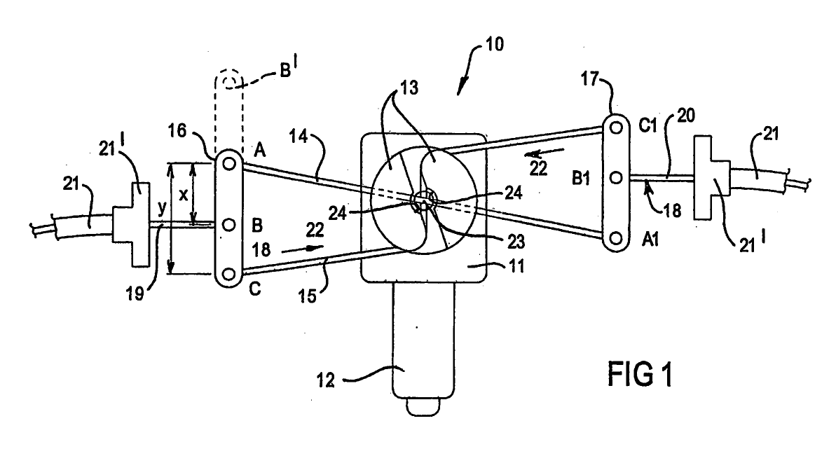

FIG. 1 is a diagrammatic illustration of an electric brake actuating assembly according to one form of the invention.

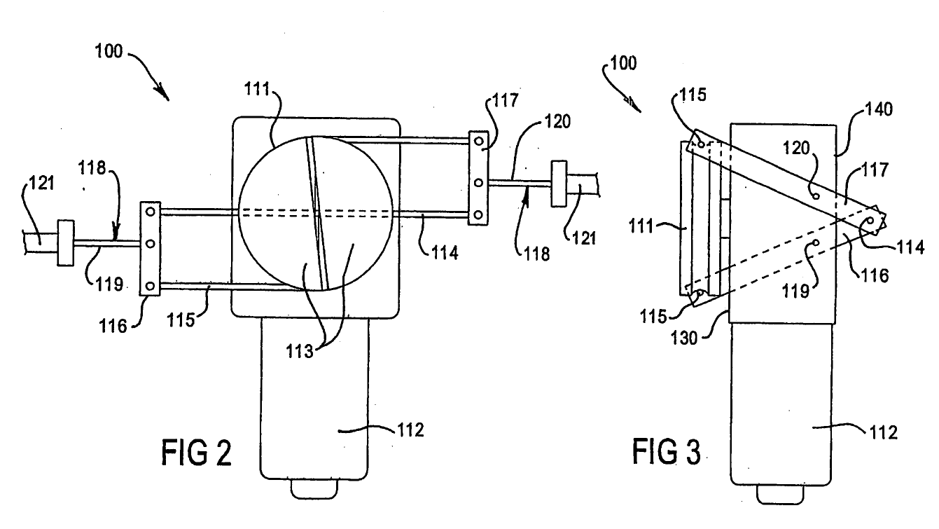

FIG. 2 is a diagrammatic illustration of an electric brake actuating assembly according to an alternative form of the invention.

FIG. 3 is a side view of the assembly of FIG. 2.

In the assembly 10 illustrated in FIG. 1, a rotatable actuator 11 is shown, along with a mounting structure 12 for fixedly mounting the rotatable actuator 11 against movement other than rotating movement. The mounting structure 12 could for example, be mounted to part of a vehicle chassis, or to the rear axle or the differential. A drive arrangement to drive the rotatable actuator 11 forms part of the mounting structure 12, although the drive arrangement is not illustrated in FIG. 1. Typically the drive arrangement would comprise an electric motor and a drive shaft which would be fixed to the rotatable actuator 11, such as by a keyway or a splined connection, although transmission between the drive shaft and the rotatable actuator 11 may be via a geared arrangement, to reduce the drive shaft revolutions applied to the rotatable actuator 11.

The rotatable actuator 11 is of a kind described and illustrated in applicant's International application WO 03/008248 discussed earlier. Thus, the rotatable actuator 11 includes a pair of generally semi-circular lobes 13 which are spaced apart to define a passage or gap therebetween. The external periphery of the lobes 13 defines a groove (not shown), for cable location.

The assembly 10 further includes a link arrangement in the form of a cable 14 and an actuator cable arrangement in the form of a cable 15. The link and actuator cables 14 and 15 extend between a pair of load transfer members 16 and 17. The link cable 14 comprises a single uninterrupted cable, which is anchored at either end, at cable connections A and A1. The actuator cable 15 also comprises a single cable, and that cable extends between the load transfer members 16 and 17, between cable connections C and C1, but the cable 15 also extends into engagement with the rotatable actuator 11. The engagement is such that the cable 15 engages a first of the lobes 13, extends through the gap between the lobes 13 and engages the other of the lobes 13. The cable 15 is captured within the previously described groove provided in each of the lobes 13.

Also connected to each of the load transfer members 16 and 17, are brake assembly connections 18, and the cable connections for these arrangements 18, are located respectively at B and B1, which are between the earlier described cable connections A, A1 and C, C1. The brake cable arrangements 18 comprise cables 19 and 20 which each extend into a conduit 21 and the end of the conduits 21 which face the load transfer members 16 and 17, are grounded, preferably against a housing (not shown).

The assembly 10 is operable as follows. By rotation of the rotatable actuator 11 in an anti-clockwise direction, a pull load is applied to the actuator cable 15 in the direction of arrows 22. That pull load causes the load transfer members 16 and 17 to rotate about the fulcrum created at the cable connections A and A1, and to apply a pull load to the cables 19 and 20. The cables 19 and 20 will shift toward the rotatable member 13 within the conduits 21, and by that movement can therefore actuate the brake assemblies to which the assembly 10 is connected. The ends 21′ of the conduits 21 are fixed in place, such as to a housing that houses the assembly 10, or to a stationary part of the vehicle.

The actuator cable 15 can be substantially secured against translational movement through or relative to the rotatable actuator 11, by a suitable arrangement that causes it to remain fixed relative to the actuator 11. In FIG. 1, a stop or abutment 23 is shown fixed to the cable 15 at a point approximately midway between the points of engagement of the cable 15 with the lobes 13. The abutment 23 is positioned within a pair of facing recesses 24 formed in facing surfaces of the lobes 13, the recesses 24 allowing the abutment 23, fixed to the cable 15, to be inserted into the gap between the lobes 13. Once inserted, the abutment 23 is trapped within the section of the gap between the lobes 13 at which the facing recesses 24 are provided and thus, by the abutment 23 being fixed to the cable 15, the cable 15 is likewise secured against translational movement through or relative to the rotatable actuator 11.

The abutment 23 could take other forms and for example, could have curved outer surfaces which match the curvature of the recesses 24, so that the abutment 23 fits closely or snugly within the recesses 24.

The abutment 24 can be fixed to the cable 15 by crimping or by other suitable fixing, or the cable 15 could be formed in two parts and the abutment could connect the two parts together. The former arrangement is preferred, as being more likely to provide a cable of greater strength.

It will be appreciated that in the assembly 10, each of the link cables 14 and the brake cables 19 and 20 could comprise rigid members rather than cables. This would be appropriate for example, if it was desirable that the brake cables 19 and 20 are operated in compression rather than tension. An example of where this might be useful in practice, is shown in FIG. 1 in relation to the load transfer member 16, in which the connection B′ is provided in an extension of the load transfer member shown in dot outline. Thus, the connection B′ is disposed on the opposite side of the cable connection A to that of the cable connection C. In that arrangement, when the actuator cable 15 is pulled in the direction of arrow 22, the connection B′ will rotate anti-clockwise about the fulcrum of the cable connection A, so requiring a compression member to apply the actuating force to the brake assembly.

The assembly 10 can provide various advantageous results. Firstly, load magnification or intensification is achieved by applying a load to the cables 19 and 20 through the load transfer members 16 and 17. The load magnification is a ratio of the distances y/x and it will be easily appreciated, that as the cable connections B, B1 shift towards the cable connections A, A1, the magnification of load increases.

Secondly, the assembly 10 is self-equalising in respect of the loads applied through the cables 19 and 20, because the load transfer members 16 and 17 are not grounded, but instead can float Thus, in the event of a higher displacement being demanded by the cable 20, each of the load transfer members can float towards the conduit 21 of the cable 20, so that the load is equalised between the respective brake assembly connections 18.

Advantageously, the rotatable actuator 11 can therefore be fixed in place, so that the requirement for a floating mounting of the kind disclosed in applicants International application WO 03/008248, is not required.

A further advantage is that thinner and more flexible cable can be used for the actuating cables as the cables of that arrangement are not required to carry the full output load (the load that the brake cable arrangements carry), but instead carry only a portion of the output load. Also, more standard, less flexible and less expensive cable can be used for the brake assembly connections, given that the cables of those arrangements are not required to route about the lobes 13 of the rotatable member.

The assembly 10 illustrated in FIG. 1 is essentially what could be called a one-dimensional assembly, in which the link and actuator cables 14 and 15, and the brake cables 19 and 20, all extend in about the same plane with assistance by suitable guiding arrangements as required. Likewise, the load transfer members 16 and 17 are planar with those cables. It is possible however to have an arrangement, which might be called a three-dimensional arrangement, in which the generally planar arrangement of FIG. 1 is altered to shift the cables and load transfer members to a non-planar arrangement.

FIGS. 2 and 3 show an assembly 100, which includes many of the same parts illustrated and described in relation to FIG. 1. Accordingly, like parts from FIG. 1 have the same reference numeral of that figure, plus 100.

It will be seen, particularly from FIG. 3, that the load transfer members 116 and 117 extend from one side of the mounting structure 112 to the other side. If the front side 130 of the mounting structure 112 is that side from which the rotatable actuator 111 extends, then the load transfer members 116 and 117 extend from that front side 130, to the rear side 140. This contrasts with the assembly 10 of FIG. 1, in which the load transfer members would extend approximately parallel to the plane of the rotatable actuator 11.

Returning to FIGS. 2 and 3, it can be seen that the link cable 114 extends between the load transfer members 116 and 117 across the rear side 140 of the mounting structure 112, while the actuator cable 115 extends across the front side 130 thereof. It will further be seen, that the brake cables 119 and 120 extend from the respective load transfer members 116 and 117 from a position between the front and rear sides 130, 140 but closer to the rear side. The brake cables can extend from positions closer to the front side but this depends on the ratio of input/output load required.

FIGS. 2 and 3 illustrate that the load transfer members and the various cables are not required to be arranged in a generally planar manner as shown in FIG. 1, and illustrate clearly that an assembly according to the invention can take a variety of different forms.

The invention described herein is susceptible to variations, modifications and/or additions other than those specifically described and it is to be understood that the invention includes all such variations, modifications and/or additions which fall within the spirit and scope of the above description.

1. An electric brake actuating assembly, comprising a rotatable actuator and electric drive means for driving said rotatable actuator to rotate, a pair of load transfer members disposed respectively on opposite sides of said rotatable actuator and each load transfer member comprising first, second, and third connections, a link arrangement connects said first connections of said load transfer members, an actuating cable arrangement connects said second connections of said load transfer members and extends in connection with said rotatable actuator, and a brake assembly connection extends from said third connections of said load transfer members, for connection to respective brake assemblies, the arrangement being such that upon rotation of said rotatable actuator in a brake actuation direction, a pull load is applied through said actuating cable arrangement to said second connections of said load transfer members to cause those members to rotate about said first connections and to cause a shift in the position of said third connections for application of an actuating load on said brake assembly connections for actuation of the brake assemblies.

2. An electric brake actuating assembly according to claim 1, wherein said actuating cable arrangement comprises an actuating cable which is a single, continuous cable.

3. An electric brake actuating assembly according to claim 1, wherein said actuating cable arrangement comprises a pair of actuating cables, each of which is fixed at one end to said actuator and each of which extends to a respective load transfer member.

4. An electric brake actuating assembly according to claim 1, wherein said rotatable actuator comprises a rotatable disc having an outer periphery which defines a groove for locating and accommodating a portion of the length of said actuating cable arrangement when said rotatable disc rotates.

5. An electric brake actuating assembly according to claim 4, wherein the outer periphery of said rotatable disc is circular or oval.

6. An electric brake actuating assembly according to claim 4, wherein said rotatable disc comprises a passage formed to extend diametrically through the rotational axis of the disc, to be open axially and to open radially at either end into the base of said groove formed in said outer periphery, said cable extending through said passage, said cable comprising an abutment in the portion thereof that extends through said passage, and said passage being configured to cooperate with said abutment to substantially secure said cable against translational movement through said passage.

7. An electric brake actuating assembly according to claim 6, wherein said passage comprises at least one recess which partly accommodates said abutment to substantially secure said cable against translational movement through said passage.

8. An electric brake actuating assembly according to claim 7, wherein said passage comprises a pair of facing recesses formed in facing sides of said passage, each said recess partly accommodating said abutment to substantially secure said cable against translational movement through said passage.

9. An electric brake actuating assembly according to claim 6, wherein said abutment is a member which is fixed to said cable.

10. An electric brake actuating assembly according to claim 1, wherein said rotatable actuator is fixed against movement, other than rotational movement.

11. An electric brake actuating assembly according to claim 10, wherein said rotatable actuator is fixed to the chassis of a vehicle.

12. An electric brake actuating assembly according to claim 10, wherein said rotatable actuator is fixed to rear axle or the differential of a vehicle.

13. An electric brake actuating assembly according to claim 1, wherein said link arrangement comprises a cable which is anchored at opposite ends to said first connections of said load transfer members, said actuating assembly being such that said cable remains in tension.

14. An electric brake actuating assembly according to claim 1, wherein said link arrangement comprises a rod, which is connected at opposite ends to said first connections of said load transfer members.

15. An electric brake actuating assembly according to claim 1, wherein each said brake assembly connection comprises a cable, which is fixed at one end to said third connections of said load transfer members and at the other end to a respective brake assembly.

16. An electric brake actuating assembly according to claim 15, wherein said cable is housed in a cable conduit, said conduit being fixed at one end thereof to a respective brake assembly and at the opposite end to a fixed abutment adjacent a load transfer member, said cable being freely moveable within said conduit.

17. An electric brake actuating assembly according to claim 16, wherein the end of said conduit which is fixed adjacent a load transfer member, is fixed to a portion of a housing which houses said rotatable actuator, so that said cable which is housed within said conduit extends from said conduit into said housing.

18. An electric brake actuating assembly according to claim 1, wherein said load transfer members are elongate levers and said three cable connections are spaced apart generally lengthwise along said levers.

19. An electric brake actuating assembly according to claim 18, wherein said third connection is provided intermediate said first and second connections.

20. An electric brake actuating assembly according to claim 19, wherein said first and second connections are provided at opposite distal ends of said levers and said third connection is provided intermediate said first and second connections.

21. An electric brake actuating assembly according to claim 18, wherein said third connection is spaced on the opposite side of said second connection to said first connection.

22. An electric brake actuating assembly according to claim 1, wherein each of said load transfer members are arranged to float toward and away from said rotatable member to facilitate load equalisation for substantially equal application of load to said brake assemblies.

23. A braking arrangement for a vehicle, comprising a pair of brake assemblies respectively associated with a pair of wheels of the vehicle, and an electric brake actuating assembly comprising a rotatable actuator and electric drive means for driving said rotatable actuator to rotate, a pair of load transfer members disposed respectively on opposite sides of said rotatable actuator and each load transfer member comprising first, second, and third connections, a link arrangement connects said first connections of said load transfer members, an actuating cable arrangement connects said second connections of said load transfer members and extends in connection with said rotatable actuator, and a brake assembly connection extends from said third connections of said load transfer members, for connection to said respective brake assemblies, the arrangement being such that upon rotation of said rotatable actuator in a brake actuation direction, a pull load is applied through said actuating cable arrangement to said second connections of said load transfer members to cause those members to rotate about said first connections and to cause a shift in the position of said third connections for application of an actuating load on said brake assembly connections for actuation of the brake assemblies.

24. A braking arrangement according to claim 23, said braking arrangement being a parking braking arrangement.

25. A braking arrangement according to claim 23, said braking arrangement being a service braking arrangement.
